(19) United States
(12) Patent Application Publication
(10) Pub. No.: US 2025/0126431 A1
(43) Pub. Date: Apr. 17, 2025

(54) INFORMATION PROCESSING APPARATUS, INFORMATION PROCESSING METHOD, AND PROGRAM

(71) Applicant: Sony Group Corporation, Tokyo (JP)

(72) Inventor: Kei TAKAHASHI, Tokyo (JP)

(73) Assignee: Sony Group Corporation, Tokyo (JP)

(21) Appl. No.: 18/293,782

(22) PCT Filed: Feb. 16, 2022
(86) PCT No.: PCT/JP2022/006051

§ 371 Date: Jan. 31, 2024

(30) Foreign Application Priority Data
Aug. 10, 2021 (JP) 2021-130552

(51) Int. Cl. H04S 7/00

(52) U.S. Cl. CPC H04S 7/304; H04S 2400/11

(57) ABSTRACT

For example, to enable optimal delay compensation adapted to a change in delay time to be performed. An information processing apparatus includes a control unit that performs processing of: predicting a total amount of delay that changes according to a state of a reproduction system including a sensor unit that senses a position of an observation target and a reproduction unit that reproduces a reproduction signal generated on the basis of sensing data of the sensor unit, the total amount of delay possibly occurring between sensing by the sensor unit and reproduction by the reproduction unit; and compensating for a delay of the predicted total amount of delay and then generating the reproduction signal.

### TECHNICAL FIELD

The present disclosure relates to an information processing apparatus, an information processing method, and a program.

### BACKGROUND ART

In a system that displays a video, there is known a method of predicting and compensating for a delay that occurs when a motion of a display target object is sensed and calculated to be displayed (see, for example, Patent Document 1).

### CITATION LIST

### Patent Document

Patent Document 1: Japanese Patent Application Laid-Open No. 2014-229157

### SUMMARY OF THE INVENTION

### Problems to be Solved by the Invention

However, the technique disclosed in Patent Document 1 does not consider a change in delay time. Therefore, the technique cannot adapt to a case where the delay time changes.

An object of the present disclosure is to propose an information processing apparatus, an information processing method, and a program that can perform optimal delay compensation adapted to the change in delay time.

### Solutions to Problems

The present disclosure is, for example, an information processing apparatus including
a control unit that performs processing of: performing prediction of a total amount of delay that changes according to a state of a reproduction system including a sensor unit that senses a position of an observation target and a reproduction unit that reproduces a reproduction signal generated on the basis of sensing data of the sensor unit, the total amount of delay possibly occurring between sensing by the sensor unit and reproduction by the reproduction unit; and compensating for a delay of the predicted total amount of delay and then generating the reproduction signal.

The present disclosure is, for example, an information processing method including performing processing of:
performing prediction of a total amount of delay that changes according to a state of a reproduction system including a sensor unit that senses a position of an observation target and a reproduction unit that reproduces a reproduction signal generated on the basis of sensing data of the sensor unit, the total amount of delay possibly occurring between sensing by the sensor unit and reproduction by the reproduction unit; and compensating for a delay of the predicted total amount of delay and then generating the reproduction signal.

The present disclosure is, for example, a program that causes a computer to execute processing of:
performing prediction of a total amount of delay that changes according to a state of a reproduction system including a sensor unit that senses a position of an observation target and a reproduction unit that reproduces a reproduction signal generated on the basis of sensing data of the sensor unit, the total amount of delay possibly occurring between sensing by the sensor unit and reproduction by the reproduction unit; and compensating for a delay of the predicted total amount of delay and then generating the reproduction signal.

### BRIEF DESCRIPTION OF DRAWINGS

FIG. 1 is a flowchart showing a basic processing flow of sound image localization.

FIG. 2 is a diagram illustrating an example of a measurement result of a head position of a user.

FIG. 3 is a diagram for describing generation of a reproduction signal corresponding to an orientation of a user.

FIG. 4 is a diagram for describing a delay time.

FIG. 5 is a diagram illustrating a configuration example of a reproduction system according to an embodiment.

FIG. 6 is a diagram for describing delay compensation by prediction.

FIG. 7 is a sequence diagram illustrating a flow of processing in the reproduction system.

FIG. 8 is a diagram for describing change in delay time.

FIG. 9 is a flowchart illustrating a flow of delay compensation processing.

FIGS. 10A to 10D are diagrams illustrating a configuration example of a table referred to at the time of obtaining an amount of delay.

FIG. 11 is a diagram for describing error of a prediction algorithm.

FIG. 12 is a diagram illustrating a configuration example of another reproduction system.

FIG. 13 is a diagram illustrating a configuration example of yet another reproduction system.

FIG. 14 is a diagram illustrating a configuration example of yet another reproduction system.

FIG. 15 is a diagram illustrating a configuration example of yet another reproduction system.

FIG. 16 is a diagram illustrating a configuration example of yet another reproduction system.

FIG. 17 is a diagram illustrating a hardware configuration example of a computer.

FIG. 18 is a diagram illustrating a configuration example of a reproduction system according to a modification.

FIG. 19 is a diagram briefly illustrating a flow of processing in the reproduction system according to the modification.

FIG. 20 is a diagram for describing sound image localization in the modification.

### MODE FOR CARRYING OUT THE INVENTION

Hereinafter, an embodiment and the like of the present disclosure is described with reference to the drawings. Note that the description is given in the following order.
1. BACKGROUND
2. Embodiment
3. Other system configuration examples
4. Hardware configuration example of computer
5. Modifications

An embodiment and the like described below are preferred specific examples of the present disclosure, and the content of the present disclosure is not limited to the embodiment and the like. Note that, in the following description, components having substantially the same functional configuration are denoted by the same reference sign, and redundant description will be omitted as appropriate.

### 1. Background

First, a background of the present disclosure is described. An absolute angle of the head of a user can be measured by attaching a motion-detectable sensor such as an inertial measurement unit (IMU) including a three-axis acceleration sensor, a gyro sensor, and the like to headphones. Furthermore, by using a 3D audio technology, sound having a sound image at an optional relative position with respect to the user can be reproduced. Then, by combining the two, the sound can be reproduced while being fixed at an absolute position so as to cancel a head motion of the user. This is called sound image localization.

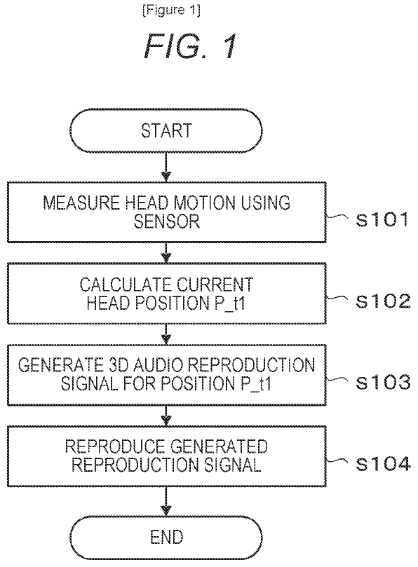

FIG. 1 is an example of a basic processing flow of the sound image localization. In order to realize the sound image localization, first, the head motion of the user is measured and acquired by a sensor such as an IMU (step S101). Next, a current head position (specifically, the absolute angle) P_t1 of the user is calculated using the measurement result (step S102).

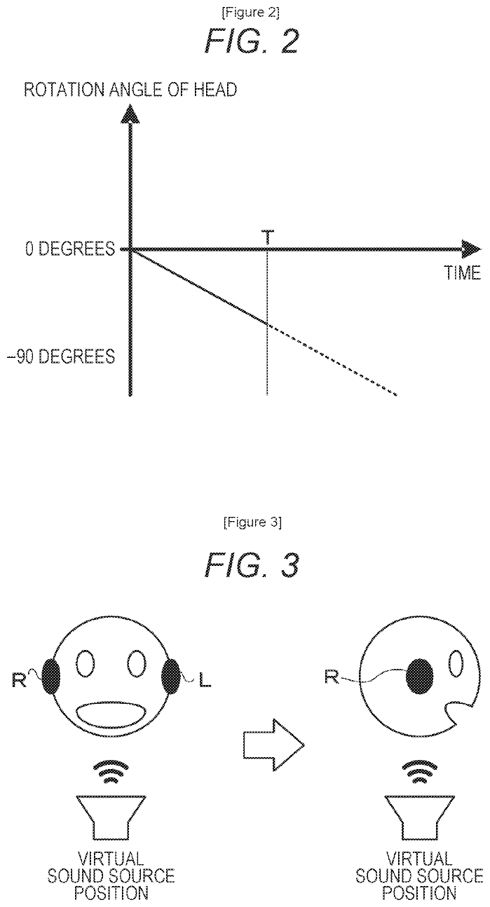

FIG. 2 is a diagram illustrating an example of the measurement result of the head position of the user. In the drawing, the horizontal axis represents a time, and the vertical axis represents a rotation angle (degree) of the head. Note that 0 degrees indicates that the user is facing forward (faces the virtual sound source position), and −90 degrees indicates that the user is facing left. That is, the case of this drawing represents that the user changes the facing direction of the head from forward to left. In the case of this example, the current head position P_t1 is obtained by measuring the rotation angle of the head at a time T (current time).

Then, when the current head position P_t1 of the user is calculated in this manner, a reproduction signal of the 3D audio corresponding to the position P_t1 is generated (step S103), and the generated reproduction signal is reproduced and sound is output (step S104).

For example, as illustrated in FIG. 3, in a case where the user faces forward with respect to a virtual sound source position, the reproduction signal is generated such that sound is output in a balanced manner from both L and R sides (both left and right ear sides) of a headphone. Then, in a case where the user turns left from this state, the motion is detected, and the reproduction signal is generated such that the sound is mainly output from the R side (right ear side) of the headphone. By generating and reproducing the reproduction signal according to the head position in this manner, the user can feel that the sound is stationary in the real space. Note that the present invention is not limited to the lateral rotation as illustrated in the drawing, and the similar applies to rotation in other directions.

However, this method has the following problems. A processing time and a communication time are required from when the head of the user moves to when the sound image localized sound is reproduced and output. The processing time and the communication time are collectively referred to as a delay time. When the delay time becomes equal to or more than a certain value (for example, 100 ms or more), the calculation of the position of the sound image is deviated with respect to the position of the user, and the user cannot recognize that the sound generation source is stationary.

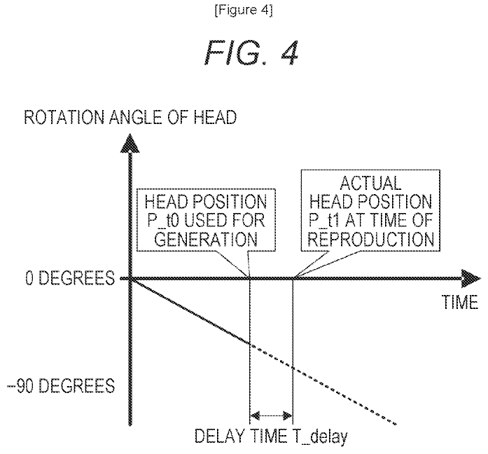

For example, as illustrated in FIG. 4, it is assumed that a time T_delay is taken from acquisition of the head motion of the user to reproduction of the sound. In this case, according to the above method, the actual head position at the time of sound reproduction is P_t1, whereas the head position used for sound reproduction (head position at the time of generation) is a position P_t0 earlier by the time T_delay, causing a deviation to occur by the amount of delay. The present disclosure proposes a technique of compensating for such a deviation due to a delay.

### 2. Embodiment

### 2-1. Configuration Example of Reproduction System

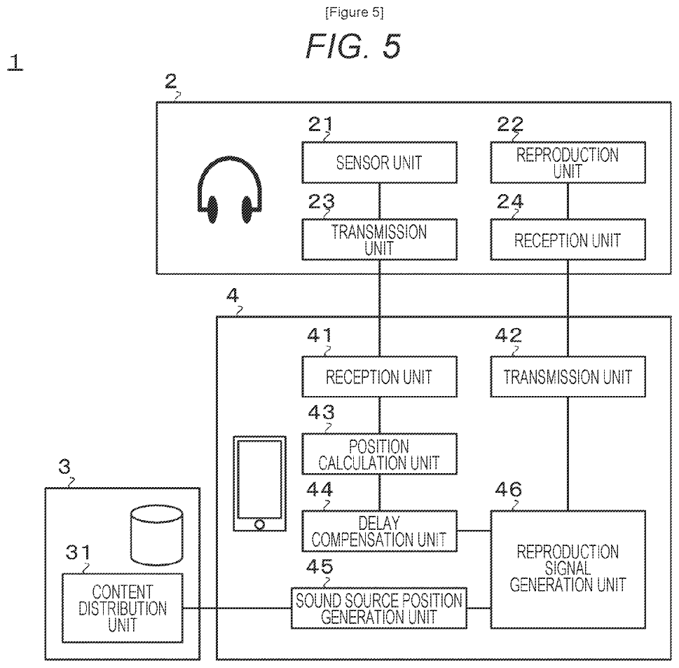

FIG. 5 is a diagram illustrating a configuration example of a reproduction system (reproduction system 1) according to an embodiment. The reproduction system 1 is a system that realizes virtual experiences such as augmented reality (AR) and virtual reality (VR) by auditory sense. The reproduction system 1 includes a reproduction device 2, a server device 3, and a terminal device 4. Specifically, the reproduction system 1 reproduces content (for example, AR content) when the terminal device 4 executes an application. In the reproduction system 1, the reproduction device 2 senses a head facing direction of a user, and the terminal device 4 generates a reproduction signal.

The reproduction device 2 is a device that outputs a sound to cause the user to perceive the sound. Specifically, the reproduction device 2 includes headphones that can be worn on the head of the user. Note that the reproduction device 2 may include another device that can output a sound, such as earphones or a head-mounted display. Furthermore, the device may include a headset (headphones with microphones, earphones). The reproduction device 2 includes a sensor unit 21, a reproduction unit 22, a transmission unit 23, and a reception unit 24.

The sensor unit 21 senses a head position (specifically, the head facing direction) of the user to be an observation target, and outputs a sensor value (sensing data) obtained by the sensing to the transmission unit 23. Specifically, the sensor unit 21 includes a sensor group including an acceleration sensor, a gyro sensor, and a geomagnetic sensor, and a sensor value reception module that receives a sensor value output from each sensor.

Note that the configuration of the sensor unit 21 is not limited thereto. For example, the number of sensors constituting the sensor unit 21 may be one or more, and may have a configuration using a single type or one sensor. For example, sensors may be provided on both ear portions of headphones. Furthermore, the type of the sensor may be a camera, a time of flight (ToF) sensor, a positioning sensor (for example, GPS), or the like. For example, the sensor unit 21 may recognize a motion by a plurality of cameras including a smartphone and a network camera (for example, a WEB camera). Moreover, the sensor unit 21 may include a motion capture system or the like that estimates an angle by having a marker attached to the head of the user. For example, the sensor unit 21 may include a tracker such as OptiTrack (registered trademark). In addition, the above sensors may be combined. That is, types, numbers, and positions of the sensors constituting the sensor unit 21 can be appropriately determined.

The reproduction unit 22 includes, for example, a pair of left and right speaker units for the left ear and the right ear, and reproduces a reproduction signal input from the reception unit 24 and outputs a sound based on the reproduction signal. Note that the reproduction signal is generated by the terminal device 4 on the basis of the sensor value of the sensor unit 21. The transmission unit 23 and the reception unit 24 include, for example, a communication module that can communicate with the terminal device 4. In the present embodiment, specifically, Bluetooth (registered trademark), that is, communication by wireless communication is assumed, but communication by wired connection may be used. Note that the wireless communication system may be Wi-Fi (registered trademark), Wireless USB (WUSB), Long Term Evolution (LTE), 5th generation mobile communication system (5G), or the like. Specifically, the transmission unit 23 transmits the sensor value input from the sensor unit 21 to the terminal device 4. Specifically, the reception unit 24 receives the reproduction signal transmitted from the terminal device 4, and outputs the received reproduction signal to the reproduction unit 22.

The server device 3 is provided on a network such as the Internet, for example, and functions as a distribution server that distributes content. The server device 3 includes a content distribution unit 31, and distributes content to the terminal device 4 as appropriate. Note that the server device 3 may be a cloud server.

The terminal device 4 is a device that generates a reproduction signal to be transmitted to the reproduction device 2. More specifically, the terminal device 4 calculates and predicts the head position of the user after the above-described delay time has elapsed on the basis of the sensor value, and generates a reproduction signal by performing sound image localization processing (processing of localizing a sound image described with reference to FIG. 3) corresponding to the predicted head position on the audio signal. Specifically, the terminal device 4 includes a smartphone. Note that the terminal device 4 may include other computer devices such as a tablet terminal, a personal computer, and a game machine. The terminal device 4 includes a reception unit 41, a transmission unit 42, a position calculation unit 43, a delay compensation unit 44, a sound source position generation unit 45, and a reproduction signal generation unit 46.

The reception unit 41 and the transmission unit 42 include, for example, a communication module that can communicate with the reproduction device 2. Note that the same communication as that described for the transmission unit 23 and the reception unit 24 described above can be used. In the present embodiment, specifically, Bluetooth is used. Specifically, the reception unit 41 receives the sensor value transmitted from the transmission unit 23 of the reproduction device 2, and outputs the received sensor value to the position calculation unit 43. Specifically, the transmission unit 42 transmits the reproduction signal input from the reproduction signal generation unit 46 to the reproduction device 2.

The position calculation unit 43 includes, for example, a head facing direction calculation module, and calculates the head position of the user. Specifically, the position calculation unit 43 calculates the current head position of the user using the sensor value input from the reception unit 41, and calculates a prediction function for calculating the future head position. Because the motion of the head of the user is continuous, the future motion can be predicted from the motion over time. Therefore, for example, the position calculation unit 43 holds the motion of the head of the user in time series, and performs regression analysis from the history to calculate the prediction function. The delay compensation unit 44 includes, for example, a delay compensation module, calculates and predicts the head position subjected to delay compensation using the calculation result (the current head position and the prediction function) of the position calculation unit 43, and outputs the predicted head position to the reproduction signal generation unit 46.

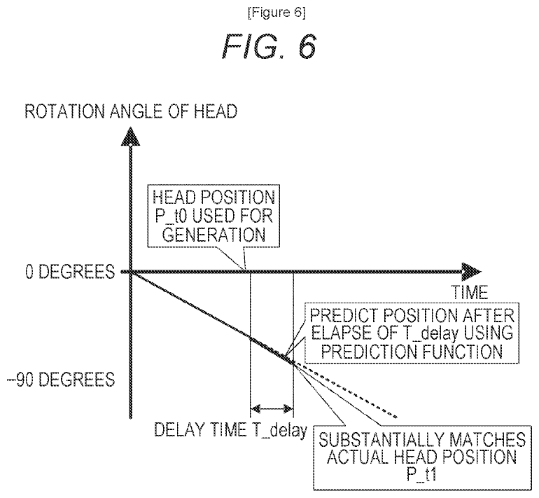

FIG. 6 is a diagram for describing the delay compensation by prediction. The position calculation unit 43 calculates the current head position P_t0, and calculates the prediction function P(t) of the position from the history of the head positions. The delay compensation unit 44 uses the position P_t0 and the prediction function P(t) to calculate and predict the head position after the delay time T_delay has elapsed, specifically, the position P(t0+T_delay). This predicted head position substantially matches (including exact match) the actual head position P_t1.

The sound source position generation unit 45 includes, for example, a module that generates a sound source position from content. The sound source position generation unit 45 acquires the content sent from the server device 3, generates a sound source position from the acquired content, and outputs the generated sound source position to the reproduction signal generation unit 46.

The reproduction signal generation unit 46 includes, for example, a reproduction signal generation module. The reproduction signal generation unit 46 generates a 3D audio reproduction signal on the basis of the head position input from the delay compensation unit 44 and the sound source position input from the sound source position generation unit 45, and outputs the generated reproduction signal to the transmission unit 42. That is, the reproduction signal generation unit 46 generates the reproduction signal corresponding to the head facing direction of the user with respect to the sound source position. Specifically, the reproduction signal is generated as described with reference to FIG. 3.

Specifically, the reproduction signal generation unit 46 uses a virtual surround technology for generating a reproduction signal of 3D audio. As the virtual surround technology, for example, VPT (registered trademark of Sony Corporation) can be adopted. Virtualphones technology (VPT) is a technology to measure a head related transfer function (HRTF) as transmission characteristics from a sound source to both ears, and convolutes the measured HRTF in an input signal, to realize out-of-head localization of a sound image and sound field reproduction that causes the feeling of listening to sound (for example, sound of 5.1 channel or 7.1 channel) from a speaker arranged around the user although the reproduction is performed from two-channel headphones. Note that the reproduction signal to be generated is not limited thereto, and for example, reproduction signals having more than two channels may be generated.

According to the reproduction system 1 having the above configuration, because the reproduction signal corresponding to the head position in which the deviation due to the delay is compensated for can be generated and reproduced, the user can have a good experience of sound image localization.

### 2-2. Example of Processing Flow in Reproduction System

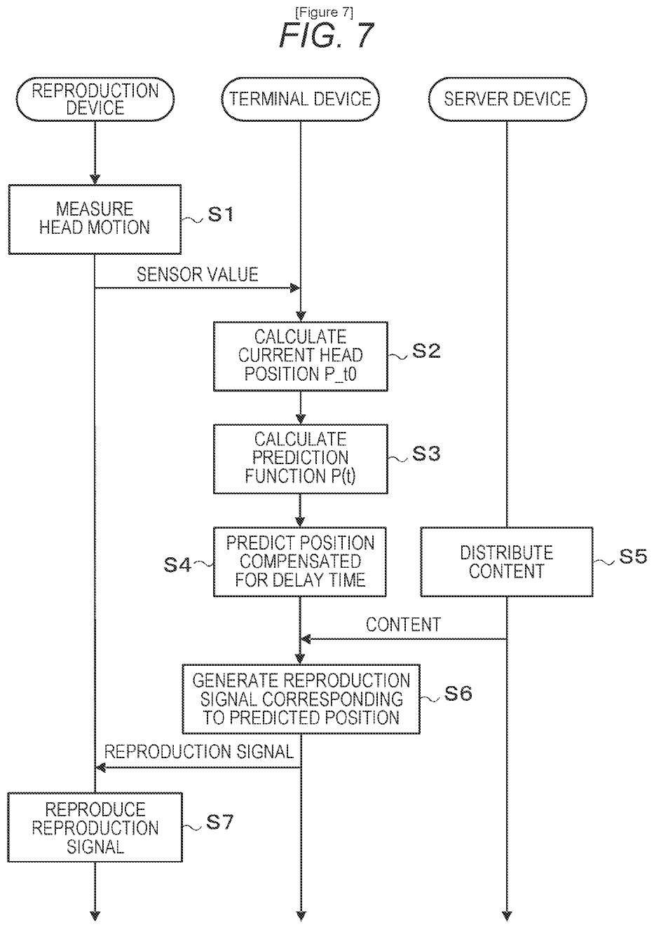

FIG. 7 is a sequence diagram illustrating an example of a flow of processing in the reproduction system 1. First, the reproduction device 2 measures a head motion of the user (step S1). That is, the sensor unit 21 outputs a sensor value obtained by sensing to the transmission unit 23, and the transmission unit 23 transmits the sensor value to the terminal device 4.

Next, the terminal device 4 calculates the current head position P to of the user (step S2). That is, the reception unit 41 receives the sensor value transmitted from the transmission unit 23 of the reproduction device 2, and outputs the sensor value to the position calculation unit 43. Then, the position calculation unit 43 calculates the current head position P to of the user using the sensor value, and outputs the calculation result to the delay compensation unit 44.

Then, the terminal device 4 calculates the prediction function P(t) (step S3). Specifically, the position calculation unit 43 calculates the prediction function P(t) and outputs the calculation result to the delay compensation unit 44.

Next, the terminal device 4 predicts a head position of the user compensated for the delay time T_delay (step S4). More specifically, the delay compensation unit 44 calculates and predicts the head position compensated for the delay time T_delay using the calculation result of the position calculation unit 43, and outputs the result to the reproduction signal generation unit 46.

Meanwhile, the server device 3 distributes content to the terminal device 4 (step S5). Specifically, the content distribution unit 31 distributes the content to the terminal device 4 as appropriate according to a predetermined condition such as the position of the user.

Next, a reproduction signal corresponding to the content is generated according to the position predicted by the terminal device 4 (step S6). That is, the sound source position generation unit 45 generates a sound source position from the acquired content transmitted from the server device 3, and outputs the generated sound source position to the reproduction signal generation unit 46. Next, the reproduction signal generation unit 46 generates a reproduction signal on the basis of the head position input from the delay compensation unit 44 and the sound source position input from the sound source position generation unit 45, and outputs the generated reproduction signal to the transmission unit 42. Then, the transmission unit 42 transmits the reproduction signal to the reproduction device 2.

Finally, the reproduction device 2 reproduces the reproduction signal and outputs a sound (step S7). More specifically, the reception unit 24 receives the reproduction signal transmitted from the terminal device 4 and outputs the reproduction signal to the reproduction unit 22. Then, the reproduction unit 22 reproduces the reproduction signal and outputs the sound. In this manner, by predicting the future head position of the user after the delay time has elapsed and reproducing the sound corresponding to the head position, the user can have a good experience of sound image localization.

Incidentally, the delay time varies depending on a system configuration, a radio wave condition, a process to be executed, and the like. For example, in a case where the reproduction device 2 and the terminal device 4 are connected to each other wirelessly (for example, by Bluetooth), the time required for a signal from the reproduction device 2 to be transmitted to the terminal device 4 changes depending on the radio wave condition. In addition, the calculation time for generating the reproduction signal of the 3D audio also changes depending on the number of sound images and the like.

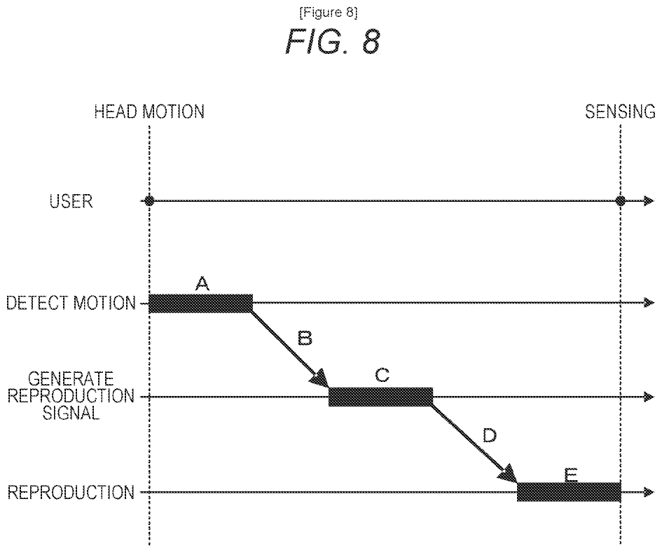

FIG. 8 is a diagram for describing change in delay time. For example, in the reproduction system 1 described above, the delay can be decomposed into the following five elements.
1. Delay (Delay A) occurring during acquisition of sensor value
2. Delay (Delay B) occurring during communication of sensor value
3. Delay (Delay C) occurring during generation of reproduction signal
4. Delay (Delay D) occurring during communication of reproduction signal
5. Delay (Delay E) occurring during reproduction

The delays A and E are delays specific to the reproduction device 2, the delays B and D are delays that change depending on a communication method, a radio wave condition, and the like, and the delay C is a delay that changes depending on processing contents such as the number of sound sources to be reproduced and the type of sound (specifically, speech content, music content, and the like).

As described above, because each delay time is not constant and changes depending on a configuration, a condition, a situation, and the like, the delay compensation time needs to be changed accordingly. Furthermore, there is a case where the delay compensation time is considered difficult to be predicted. Therefore, the delay compensation unit 44 described above predicts the delay time from the connected device, profile, and the like, and sets an optimum prediction time.

Specifically, the delay compensation unit 44 sets an optimum delay compensation time by the following delay compensation processing, and calculates the head facing direction according to the set delay compensation time.

### 2-3. Example of Flow of Delay Compensation Processing

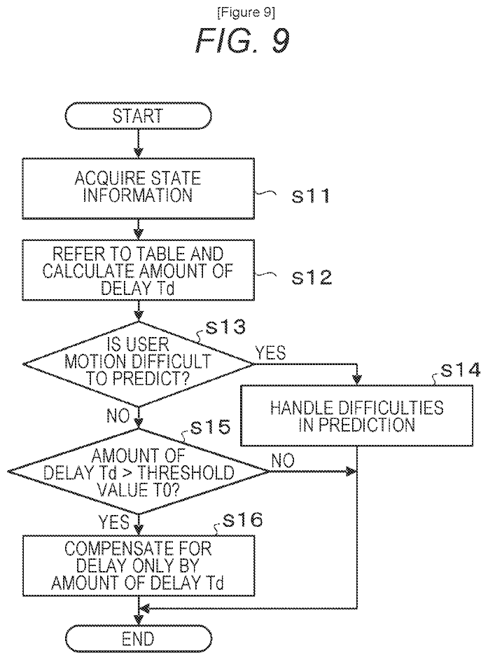

FIG. 9 is a flowchart illustrating a flow of the delay compensation processing. First, the delay compensation unit 44 acquires state information representing the current state of the reproduction system 1 (step S11). Specifically, the delay compensation unit 44 acquires information that enables distinguishing of each of the delays A to E described above. Specific examples of the information for distinguishing the delays A and E unique to the device described above include a model name (which may include a manufacturer name) of the device or information for identifying the model. As described above, the state information includes information regarding the model of the reproduction device including the sensor unit 21 and the reproduction unit 22 and the terminal device 4 that generates the reproduction signal.

Furthermore, specific examples of the information for distinguishing the delays B and D related to communication include information on elements involved in the communication delay (for example, a connection profile, a communication buffer size, a connection status, and the like). The connection status information is, for example, communication delay information from a communication application programming interface (API), a packet retransmission rate, a communication bit rate, and the like. As described above, the state information includes information regarding the setting of wireless communication in a case where the wireless communication is performed between the sensor unit 21 and the reproduction unit 22.

Furthermore, examples of the information for distinguishing the delay C include information for identifying processing contents such as a content type, a content name, and the number of sound sources. As described above, the state information includes information regarding the content.

Next, the delay compensation unit 44 acquires setting information (table in this example) representing a preset amount of delay (delay time) in each state of the reproduction system 1. Then, the amount of delay of the current state of the reproduction system 1 indicated by the state information is read from the setting information, and the total amount of delay Td that can occur between the sensing by the sensor unit 21 and the reproduction by the reproduction unit 22, the total amount changing according to the state of the reproduction system 1, is calculated and predicted using the amount of delay that has been read (step S12). Specifically, the amount of delay corresponding to each piece of state information is read from the table, and the total amount of delay Td is calculated.

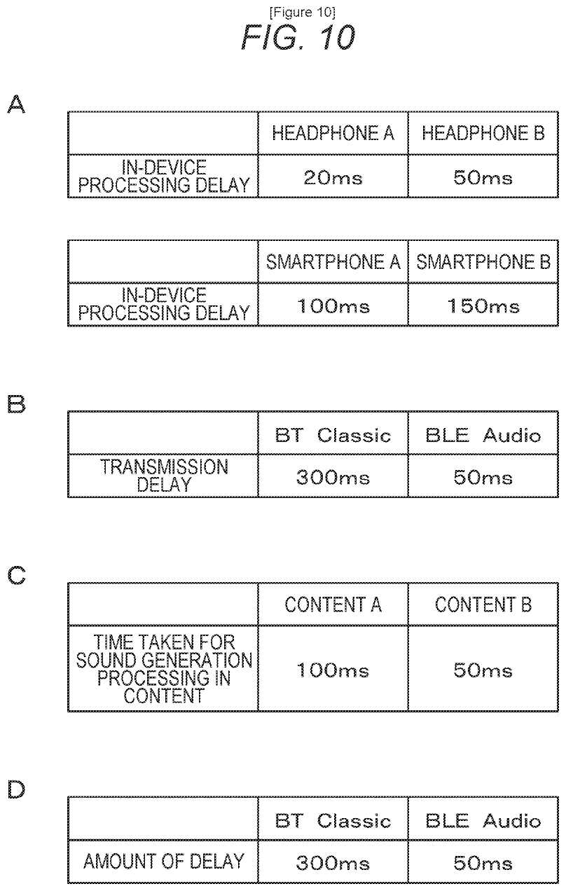

FIG. 10 is a diagram illustrating a configuration example of the table referred to at the time of obtaining the amount of delay Td. FIG. 10A is a configuration example of a table for reading the amounts of delay of the delays A and E, and models (for example, headphones A and the like) of the reproduction device 2 and the terminal device 4 are associated with the amount of delay of the processing delay in the device of the model. FIG. 10B is a configuration example of a table for reading the amounts of delay of the delays B and D, and the profile of the wireless connection and the amount of delay of the transmission delay are associated with each other. Note that Classic Audio is the existing standard for Bluetooth audio signal transmission, and Bluetooth Low Energy (BLE) Audio is the newer standard than the existing standard for Bluetooth audio signal transmission.

Furthermore, FIG. 10C illustrates a configuration example of a table for reading the amount of delay of the delay C, and the type of content to be reproduced (for example, content A) is associated with the time required for the sound generation processing in the content (amount of delay caused by processing). Note that content to be subjected to delay compensation for the motion of the user and content not to be subjected to delay compensation therefor may be set. In this case, for example, because a sound coming from a far place does not have a strong sense of localization, delay compensation may not be performed, but it is desirable to perform delay compensation on a sound of which delay is concern, such as a nearby voice.

FIG. 10D is a configuration example in a case where the amount of delay Td is calculated in one table, and a profile of wireless connection is associated with the amount of delay Td. In this manner, the amount of delay Td may be calculated by reading one table. Specifically, the delay compensation unit 44 refers to such a table and adds up all the amounts of delay of the delays A to E described above to obtain the amount of delay (predicted delay time) Td. If it is effective, only a part of the delays may be added up and calculated. Note that the amount of delay in the table is acquired and stored in advance by preliminary measurement or the like.

Here, each amount of delay is not limited to being acquired by referring to the table. For example, an audio signal may be actually reproduced from the reproduction device 2 in a calibration mode to output a sound, and the sound may be detected by a microphone (specifically, a microphone of a smartphone) included in the terminal device 4 to measure the delay. That is, the amount of delay Td may be predicted by a value actually measured in advance. Furthermore, each amount of delay may be acquired, for example, by reading a set value of a module from a storage location. In addition, the above methods may be appropriately combined to acquire each amount of delay. For example, a part of the amount of delay may be obtained by referring to the table, and a part of the amount of delay may be obtained by reading a setting value of the module. Note that, in a case where the amount of delay cannot be acquired in a device or the like that is not registered in the table in advance, for example, a predetermined amount of delay (default setting value) may be used, or the amount of delay may be calculated as zero.

Here, calculation timing of the amount of delay Td is only required to be before the reproduction signal is generated. For example, the calculation may be performed in advance at the time point when the reproduction device 2 and the terminal device 4 are paired, or may be calculated at the timing when an application is activated.

Next, the delay compensation unit 44 determines whether or not the motion of the user is difficult to predict (step S13). In a case where the user is moving vigorously, the prediction is difficult, it is also difficult for the user to perceive localization of sound. This is because the prediction function can reproduce the actual behavior well in a case where the frequency of the motion of the user is low, but the deviation between the prediction function and the actual behavior increases in a case where the user is moving vigorously, that is, in a case where the motion of the user has many high frequency components. Furthermore, in a case where the delay time is long (for example, one second), prediction is also difficult, and the effect of compensation becomes small.

Therefore, the delay compensation unit 44 determines whether or not the prediction is difficult by determining whether or not the motion of the user is vigorous and whether or not the delay time (amount of delay Td) is longer than a predetermined time (for example, one second). That is, it is determined that the prediction is not difficult in a case where the motion of the user is not vigorous and the delay time is within a predetermined time, and it is determined that the prediction is difficult in other cases (in a case where the motion is vigorous or in a case where the amount of delay Td exceeds the predetermined time).

The vigorous motion of the user can be determined, for example, by the following calculation. By applying a high-pass filter (HPF) to the position vector (x, y, z) and calculating the norm, a high-frequency component of the position change can be obtained. This value is integrated for the past t seconds, and if the value is equal to or more than a predetermined threshold, it is considered that there is the vigorous motion. Note that the method for obtaining the vigorous motion of the user is not limited thereto. For example, the integration of positions, that is, the number of times the sign of the angular velocity has been reversed in the past t seconds may be examined, and if the number of times is equal to or more than a predetermined threshold value, it may be considered that there is the vigorous motion. Furthermore, the prediction result of the position is compared with the actual measurement value, the deviation of the prediction value in the past t seconds is integrated, and if the deviation is equal to or more than a predetermined threshold value, it may be considered that the motion is vigorous. In addition, the above methods may be combined.

Note that there are many cases where the prediction for a user who tends to move vigorously fails. Therefore, for example, after a user is specified and in a case where the user is determined to be a user who tends to move vigorously, it is determined that the motion of the user is difficult to predict. With this arrangement, the determination processing can be simplified.

In a case where it is determined in step S13 that the motion of the user is difficult to predict (YES), the delay compensation unit 44 handles the difficulties in prediction (step S14). In order to handle the difficulties in prediction, for example, prediction may be turned off (delay compensation is not performed), or in the case of using a plurality of sensors as in the present embodiment, the prediction may be attempted by changing the sensor to be used. Furthermore, for example, delay compensation (for example, delay compensation of 150 ms is performed for 300 ms) may be performed by shortening an amount of prediction so that the time becomes shorter than the amount of delay Td, or prediction restriction may be performed so that the prediction is performed only up to a predetermined position. Moreover, for example, a mode may be switched to a mode for generating a reproduction signal of low quality (low sound quality) with a delay smaller than that occurring when a normal reproduction signal is generated, or the delay on the system side may be reduced by adjusting the buffer size. In a case where it is determined that the motion of the user is vigorous and the prediction is difficult, for example, a parameter of sound image localization may be changed or a filter effect may be applied to make the delay difficult to be noticed. For example, the Doppler effect may be simulated. In a case where the delay compensation is incomplete, such as a case where the delay compensation is not performed, the acoustic effect or the intensity may be adjusted to obscure the position sense. Furthermore, the above measures may be combined. The optimum reproduction signal can be generated by the above measures.

Here, an example of switching the sensor to be used described above is described. In the case of a configuration in which a plurality of types of sensors can be used, the accuracy and speed of processing vary depending on the type, the number, or the position of the sensor to be used. For example, a gyro sensor is fast, but has low accuracy in obtaining an absolute angle. On the other hand, a geomagnetic sensor acquires the absolute angle outdoors with high accuracy but at low speed. Furthermore, in a case of a configuration in which sensors are provided in both ear portions, the accuracy becomes higher than that in a case where only one sensor is provided, but communication overhead occurs. In the case of a configuration in which a plurality of cameras including a smartphone and a network camera is used to recognize the motion, the accuracy is improved, but a communication delay is increased. Therefore, switching of the sensor to be used is performed, for example, as follows.

First, a maximum amount of delay Tmax is set for the sensor. Then, for a sensor whose amount of delay is equal to or less than the maximum amount of delay Tmax, time stamps are compared, and the delay compensation processing is performed in accordance with the sensor at the latest time. On the other hand, in a case where the amount of delay exceeds the maximum amount of delay Tmax, or in a case where the accuracy and reliability of each sensor are lower than predetermined set values, the delay compensation is performed without using the sensor. With this arrangement, for example, it is possible to take measures such as not using a geomagnetic sensor with a large delay and not using a camera with a large communication delay for recognition. In this way, an increase in the amount of delay Td can be suppressed and a state in which the prediction is difficult is resolved. Furthermore, the sensors may be switched with emphasis on the accuracy and reliability. That is, in a case where the user moves vigorously, switching may be performed to use a sensor with high accuracy. In this manner, the sensor is only required to be switched as necessary.

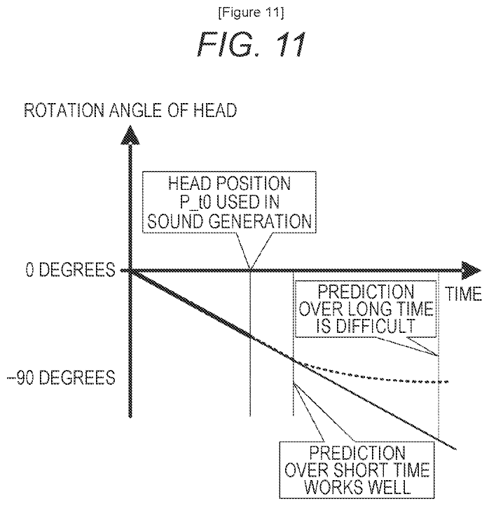

Next, an example of the above-described prediction restriction is described. In the prediction algorithm as described above, a prediction function of the motion is obtained, and a position after a specified time is obtained on the basis of the prediction function. FIG. 11 is a diagram for describing error of a prediction algorithm. As illustrated, in the prediction algorithm, the actual future position can be predicted with a small error in a short-time prediction. However, in a case where the prediction time, that is, the amount of delay Td is long, or in a case where the motion of the user is large as described above, there is a high possibility that the error increases (overshoots).

As a countermeasure against this, it is effective to set an upper limit to the amount of prediction in the algorithm. Because the human head has a limit on the rotation angle, an angle at which the human head can move in the predicted time is limited (for example, in the case of 300 ms, 30 degrees is a limit value, or the like). Therefore, a value smaller than this angle is set as an upper limit value, and in a case where the amount of prediction exceeds this value, the prediction is terminated at the upper limit value. That is, in a case where the total amount of delay Td exceeds the upper limit of the amount of prediction set in advance, the delay is compensated only up to the upper limit of the amount of prediction. Therefore, appropriate prediction can be efficiently performed.

Furthermore, it is effective to stop the prediction at a position where the front side of face faces the sound source position, assuming that the user is probably facing the direction from which the sound is coming. For example, in a case where sound that is sound image localized at an absolute position of 90 degrees is emitted and the user starts to move from 0 degrees, the user is likely to face the angle of 90 degrees. Therefore, even in a case where the head angle of the user is calculated to be, for example, 100 degrees by the prediction function, the prediction exceeding 90 degrees is set to 90 degrees. In this manner, by setting the upper limit of the amount of prediction to the amount until the position of the user faces the position (sound source position) where the sound image is localized, appropriate prediction can be efficiently performed.

On the other hand, in a case where it is determined in step S13 that the motion of the user is not difficult to predict (NO), the delay compensation unit 44 determines whether or not the amount of delay Td is larger than a predetermined threshold value TO (step S15). Here, in a case where the amount of delay Td is a small value (for example, 20 ms or less), a human cannot perceive the delay. Therefore, this unperceivable value is set as the threshold value TO.

In a case where it is determined in step S15 that the amount of delay Td is smaller than the threshold value TO (NO), the processing ends without performing delay compensation. With this arrangement, the processing can be simplified in a case where the delay compensation is not effective.

On the other hand, in a case where it is determined in step S15 that the amount of delay is larger than the threshold value (YES), the delay compensation is performed for the time of the amount of delay Td (step S16), and the processing ends. Note that the delay compensation time may be set to a value smaller than the amount of delay Td. For example, the amount of delay Td may be set to be smaller by an amount in a range of up to 20 ms in consideration of the human perception range described above.

### 2-4. Conclusion

In the reproduction system 1 according to the present embodiment, because the delay compensation can be performed by appropriately setting the amount of delay Td, the user can experience comfortable sound image localization regardless of the usage environment of the user such as the use model, the communication environment, and the use content.

In a case where the accurate delay prediction is difficult due to the vigorous motion the user or the like, there is a case where the experience of the user is deteriorated by performing delay compensation by the simply predicted amount of delay Td. However, in the reproduction system 1 according to the present embodiment, in a case where delay prediction is difficult, the fact that the prediction is difficult is detected and handled (for example, prediction is not performed), which can prevent such deterioration of the experience.

In particular, in a case where there is a plurality of sensors having different amounts of delay, by changing the sensor to be used according to the delay time of the sensor, an increase in delay due to the addition of an extremely slow sensor can be prevented.

### 3. Other System Configuration Examples

The series of processing described above can also be applied to a reproduction system having other configurations. Hereinafter, other system configuration examples are described. Note that, in the following description, points basically different from the above-described reproduction system 1 are described, and description of the same content or common content is appropriately omitted.

### System Configuration Example 1

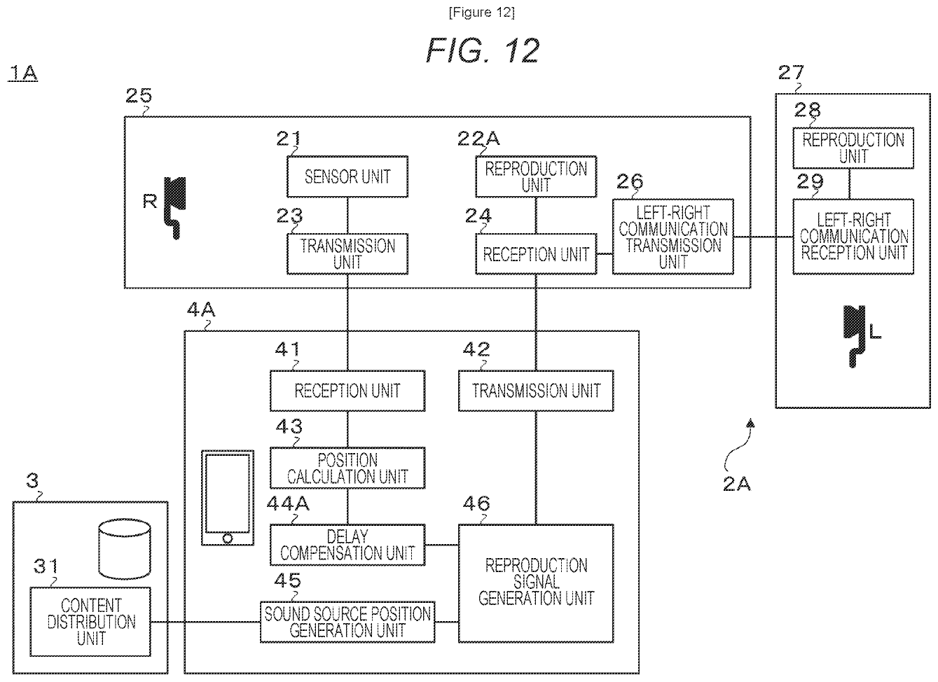

FIG. 12 is a diagram illustrating a configuration example of another reproduction system (reproduction system 1A). The reproduction system 1A includes a reproduction device 2A, a server device 3, and a terminal device 4A.

The reproduction device 2A is a device that outputs a sound to cause the user to perceive the sound. The reproduction device 2A includes a right-side reproduction device 25 for the right ear and a left-side reproduction device 27 for the left ear having separate structures. Specifically, the reproduction device 2A includes earphones (for example, an inner-type earphone) that can be worn on the head of the user.

The right-side reproduction device 25 is worn on the right ear of the user, and includes a sensor unit 21, a reproduction unit 22A, a transmission unit 23, a reception unit 24, and a left-right communication transmission unit 26. The reproduction unit 22A includes, for example, a speaker unit for the right ear. The reproduction unit 22A reproduces the reproduction signal input from the reception unit 24 and outputs a sound for the right ear based on the reproduction signal. The reception unit 24 receives the reproduction signal transmitted from the terminal device 4, and outputs the received reproduction signal to the reproduction unit 22A and the left-right communication transmission unit 26.

The left-right communication transmission unit 26 includes, for example, a communication module that can communicate with the left-side reproduction device 27. As a communication system, for example, Bluetooth is used. Note that, similarly to the communication between the transmission unit 23 and the reception unit 41 described above, another communication system may be used. Specifically, the left-right communication transmission unit 26 transmits the reproduction signal input from the reception unit 24 to the left-side reproduction device 27.

The left-side reproduction device 27 is worn on the left ear of the user, and includes a reproduction unit 28 and a left-right communication reception unit 29. The reproduction unit 28 includes, for example, a speaker unit for the left ear. The reproduction unit 28 reproduces the reproduction signal input from the left-right communication reception unit 29 and outputs a sound for the left ear based on the reproduction signal.

The left-right communication reception unit 29 includes, for example, a communication module that can communicate with the right-side reproduction device 25. As described above, as a communication system, for example, Bluetooth is used. Specifically, the left-right communication reception unit 29 receives the reproduction signal transmitted from the left-right communication transmission unit 26 of the right-side reproduction device 25, and outputs the received reproduction signal to the reproduction unit 28.

The terminal device 4A is a device that generates a reproduction signal to be transmitted to the reproduction device 2A. The terminal device 4A specifically includes a smartphone. The terminal device 4A includes a reception unit 41, a transmission unit 42, a position calculation unit 43, a delay compensation unit 44A, a sound source position generation unit 45, and a reproduction signal generation unit 46.

The delay compensation unit 44A includes, for example, a delay compensation module, calculates (calculates similarly to the delay compensation unit 44 described above) and predicts the head position subjected to delay compensation using the calculation result of the position calculation unit 43, and outputs the predicted head position to the reproduction signal generation unit 46. Here, as described above, because the reproduction device 2A performs the left-right communication by the left-right communication transmission unit 26 and the left-right communication reception unit 29, the transmission delay of the reproduction signal increases by this amount as compared with the case of the configuration of the reproduction system 1 illustrated in FIG. 5. Therefore, the delay compensation unit 44A calculates the amount of delay Td of the system by adding up the increased amount of delay. With this arrangement, even in the reproduction system 1A using the reproduction device 2A having the left-right separated configuration, optimum delay compensation can be similarly performed.

### System Configuration Example 2

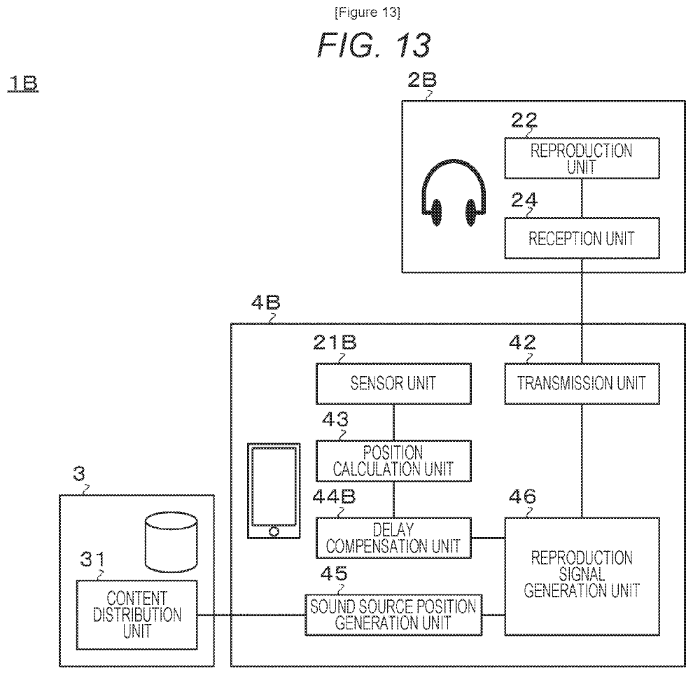

FIG. 13 is a diagram illustrating a configuration example of yet another reproduction system (reproduction system 1B). The reproduction system 1B includes a reproduction device 2B, a server device 3, and a terminal device 4B. In the reproduction system 1B, the terminal device 4B both senses the head facing direction of the user and generates the reproduction signal.

The reproduction device 2B is a device that outputs a sound to cause the user to perceive the sound. The reproduction device 2B specifically includes headphones. The reproduction device 2 includes a reproduction unit 22 and a reception unit 24.

The terminal device 4B is a device that generates a reproduction signal to be transmitted to the reproduction device 2B. The terminal device 4B specifically includes a smartphone. The terminal device 4B includes a sensor unit 21B, a reception unit 41, a transmission unit 42, a position calculation unit 43, a delay compensation unit 44B, a sound source position generation unit 45, and a reproduction signal generation unit 46.

The sensor unit 21B has a configuration similar to that of the sensor unit 21 described above, and includes, for example, a built-in sensor of a smartphone. For example, because a smartphone is used by being held in a hand so that the screen can be seen, placed on the head, suspended from the neck, or placed in a pocket, it is difficult to measure the exact head facing direction of the user, but the facing direction of the body can be measured. Therefore, the facing direction of the head can be estimated by the facing direction of the body. The sensor unit 21B senses the body position (facing direction) of the user, and outputs a sensor value obtained by the sensing to the position calculation unit 43.

The delay compensation unit 44B includes, for example, a delay compensation module, calculates (calculates similarly to the delay compensation unit 44 described above) and predicts the head position subjected to delay compensation using the calculation result of the position calculation unit 43, and outputs the predicted head position to the reproduction signal generation unit 46. Here, in the reproduction system 1B, because the terminal device 4B includes the sensor unit 21B, the sensor value does not need to be transmitted from the reproduction device 2B to the terminal device 4B. Therefore, the delay does not occur in transmission of the sensor value as compared with the case of the configuration of the reproduction system 1 illustrated in FIG. 5. Therefore, the delay compensation unit 44B calculates the amount of delay Td of the system without considering the transmission delay. With this arrangement, even in the reproduction system 1B using the reproduction device 2B not having the sensor unit 21, optimum delay compensation can be similarly performed.

### System Configuration Example 3

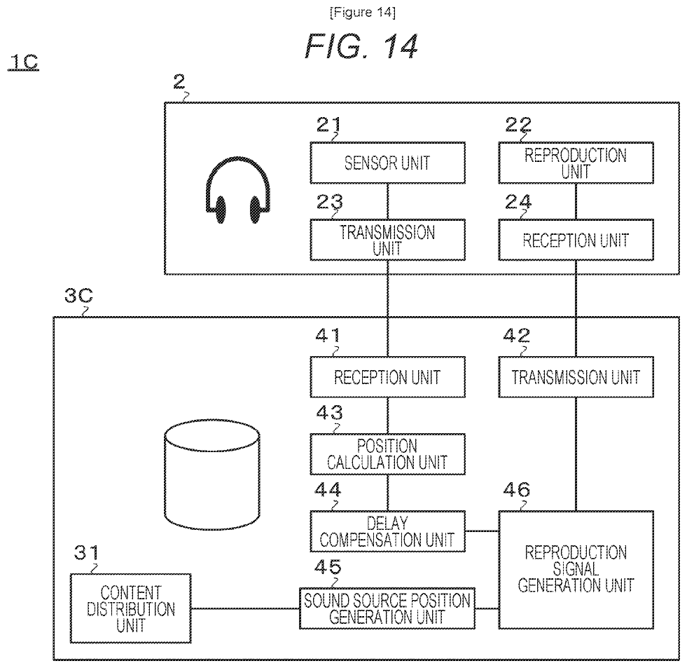

FIG. 14 is a diagram illustrating a configuration example of yet another reproduction system (reproduction system 1C). The reproduction system 1C includes a reproduction device 2 and a server device 3C. Specifically, the reproduction system 1C reproduces content when the server device 3C executes an application. In the reproduction system 1C, the reproduction device 2 senses the head facing direction of the user, and the server device 3C generates the reproduction signal. That is, the reproduction device 2 transmits the sensor value to the server device 3C, and receives and reproduces the reproduction signal transmitted from the server device 3C. The reproduction signal is, for example, streaming data. For communication between the devices, for example, cellular communication such as LTE or 5G, Wi-Fi, or the like is used.

The server device 3C is provided on, for example, a network such as the Internet, and functions as a distribution server that distributes content. The server device 3C includes a content distribution unit 31, a reception unit 41, a transmission unit 42, a position calculation unit 43, a delay compensation unit 44, a sound source position generation unit 45, and a reproduction signal generation unit 46. In this configuration, the content is directly provided from the content distribution unit 31 to the sound source position generation unit 45. With this arrangement, in the reproduction system 1C in which the head facing direction is sensed by the reproduction device 2 and the reproduction signal is generated by the server device 3C, the optimum delay compensation can be similarly performed.

### System Configuration Example 4

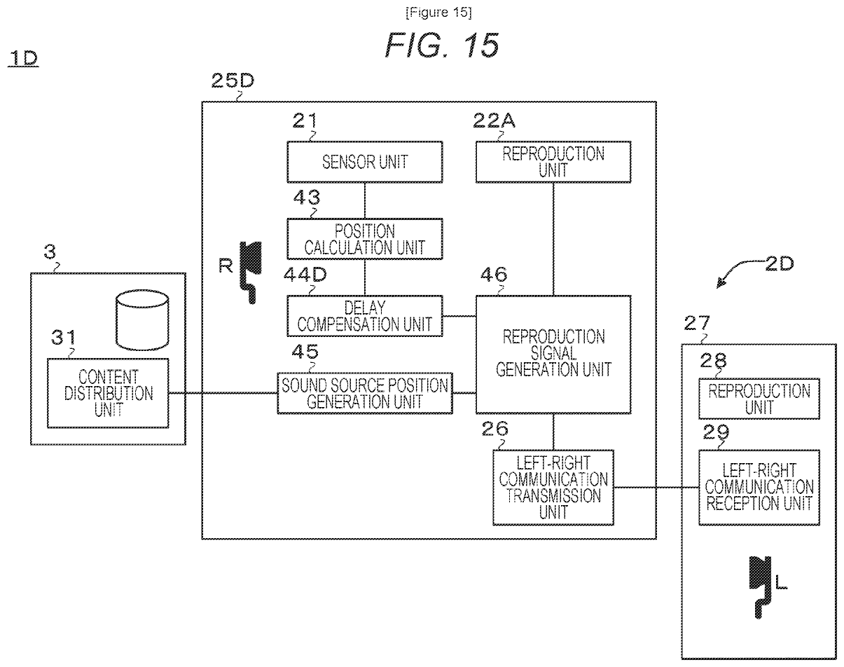

FIG. 15 is a diagram illustrating a configuration example of yet another reproduction system (reproduction system 1D). The reproduction system 1D includes a reproduction device 2D and a server device 3. The server device 3 is, for example, a cloud server. Specifically, the reproduction system 1D reproduces content when the reproduction device 2D executes an application. In the reproduction system 1D, the reproduction device 2D senses the head facing direction of the user and generates the reproduction signal. That is, the head facing direction is sensed by the reproduction device 2D, and the generation processing of the reproduction signal is applied to data (content) received from the cloud.

The reproduction device 2D is a device that outputs a sound to cause the user to perceive the sound. The reproduction device 2D includes a right-side reproduction device 25D for the right ear and a left-side reproduction device 27 for the left ear having separate structures. Specifically, the reproduction device 2D includes earphones that can be worn on the head of the user.

The right-side reproduction device 25D is worn on the right ear of the user, and includes a sensor unit 21, a reproduction unit 22A, a left-right communication transmission unit 26, a position calculation unit 43, a delay compensation unit 44D, a sound source position generation unit 45, and a reproduction signal generation unit 46. In this configuration, the sensor value is directly output from the sensor unit 21 to the position calculation unit 43. Furthermore, the reproduction signal is directly output from the reproduction signal generation unit 46 to the reproduction unit 22A and the left-right communication transmission unit 26.

The delay compensation unit 44D includes, for example, a delay compensation module, calculates (calculates similarly to the delay compensation unit 44 described above) and predicts the head position subjected to delay compensation using the calculation result of the position calculation unit 43, and outputs the predicted head position to the reproduction signal generation unit 46. Here, because the reproduction system 1D generates the reproduction signal in the right-side reproduction device 25D of the reproduction device 2D, the sensor value does not need to be transmitted and the reproduction signal does not need to be received in the right-side reproduction device 25D. Therefore, the transmission delay does not occur as compared with the case of the configuration of the reproduction system 1. A illustrated in FIG. 12. In this case, specifically, a delay in generating the reproduction signal, a delay in acquiring the sensor value, and a delay in the audio buffer and the left-right communication occur. Therefore, the delay compensation unit 44D calculates the amount of delay Td of the system related to these delays. With this arrangement, even in the reproduction system 1D using the reproduction device 2D that generates the reproduction signal, optimum delay compensation can be similarly performed.

### System Configuration Example 5

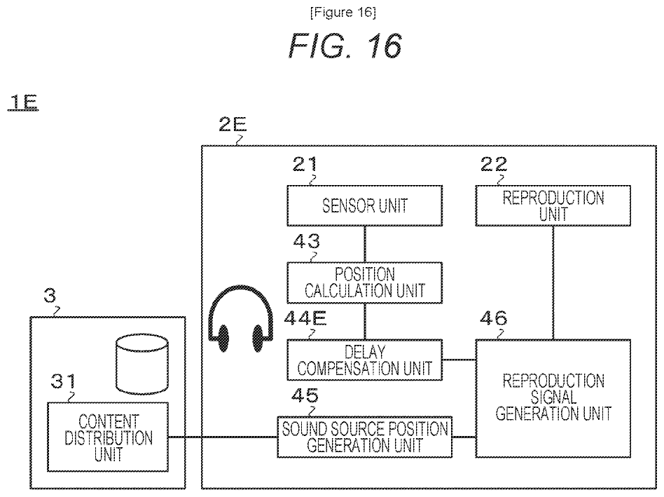

FIG. 16 is a diagram illustrating a configuration example of yet another reproduction system (reproduction system 1E). The reproduction system 1E includes a reproduction device 2E and a server device 3. Specifically, the reproduction system 1E reproduces content when the reproduction device 2E executes an application. In the reproduction system 1E, the reproduction device 2E both senses the head facing direction of the user and generates the reproduction signal.

The reproduction device 2E is a device that outputs a sound to cause the user to perceive the sound. The reproduction device 2E specifically includes headphones. The reproduction device 2E includes a sensor unit 21, a reproduction unit 22, a position calculation unit 43, a delay compensation unit 44E, a sound source position generation unit 45, and a reproduction signal generation unit 46. In this configuration, the sensor value is directly output from the sensor unit 21 to the position calculation unit 43. Furthermore, the reproduction signal is directly output from the reproduction signal generation unit 46 to the reproduction unit 22.

The delay compensation unit 44E includes, for example, a delay compensation module, calculates (calculates similarly to the delay compensation unit 44 described above) and predicts the head position subjected to delay compensation using the calculation result of the position calculation unit 43, and outputs the predicted head position to the reproduction signal generation unit 46. Here, because the reproduction system 1E generates the reproduction signal in the reproduction device 2E, the sensor value does not need to be transmitted and the reproduction signal does not need to be received in the reproduction device 2E. Therefore, the transmission delay does not occur as compared with the case of the configuration of the reproduction system 1 illustrated in FIG. 5. Note that it is necessary to consider a processing delay (for example, delay in sensor value acquisition and reproduction signal generation) for every model. Therefore, the delay compensation unit 44E calculates the amount of delay Td of the system in consideration of these delays (without considering the communication delay with respect to the head facing direction). With this arrangement, even in the reproduction system 1E using the reproduction device 2E that generates the reproduction signal, optimum delay compensation can be similarly performed.

### 4. Hardware Configuration Example of Computer

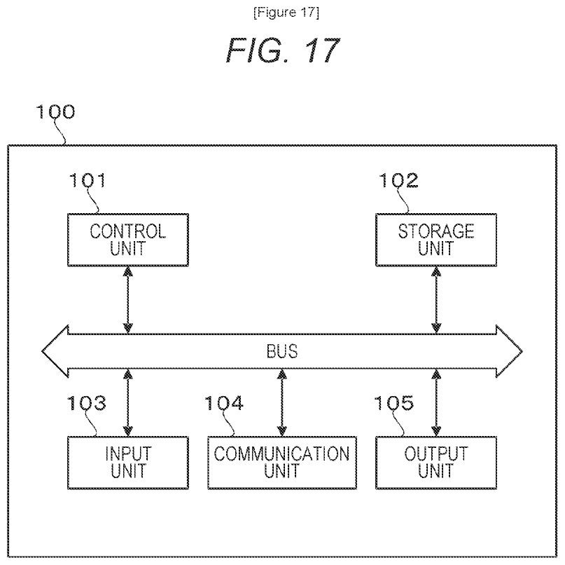

FIG. 17 illustrates a hardware configuration example of a computer (computer 100) that can be employed as an information processing apparatus (specifically, the reproduction device 2E, the server devices 3 and 3C, the terminal devices 4, 4A, and 4B, and the right-side reproduction device 25D) of the above-described embodiment. The computer 100 includes a control unit 101, a storage unit 102, an input unit 103, a communication unit 104, and an output unit 105, which are coupled to each other by a bus.

The control unit 101 includes, for example, a central processing unit (CPU), a random access memory (RAM), a read only memory (ROM), and the like. The ROM stores programs that are read and operated by the CPU, and the like. The RAM is used as a work memory of the CPU. The CPU controls the entire computer 100 by executing various processes according to a program stored in the ROM and issuing commands.

The storage unit 102 is a storage medium including, for example, a hard disc drive (HDD), a solid state drive (SSD), a semiconductor memory, or the like, and stores data of programs (for example, applications) and the like in addition to content data such as image data, video data, sound data, and text data.

The input unit 103 is a device for inputting various types of information to the computer 100. When information is input by the input unit 103, the control unit 101 performs various types of processing according to the input information. The input unit 103 may be, in addition to a mouse and a keyboard, a microphone, various sensors, a touch panel, a touch screen integrally configured with a monitor, a physical button, or the like. Note that the various types of information may be input to the computer 100 via the communication unit 104 to be described later.

The communication unit 104 is a communication module that communicates with other devices and the Internet according to a predetermined communication standard. The communication system includes a wireless local area network (LAN) such as Wireless Fidelity (Wi-Fi), LTE, 5G, broadband, Bluetooth, and the like.

The output unit 105 is a device for outputting various types of information from the computer 100. The output unit 105 is a display that displays an image or a video, a speaker that outputs a sound, or the like. Note that the various types of information may be output from the computer 100 via the communication unit 104.

The control unit 101 performs various types of processing by, for example, reading and executing programs (for example, applications) stored in the storage unit 102.

Note that the programs (for example, the applications) may not be stored in the storage unit 102. For example, a program stored in a storage medium readable by the computer 100 may be read and executed. Examples of the storage medium include, for example, an optical disk, a magnetic disk, a semiconductor memory, an HDD, and the like attachable to and detachable from the computer 100. Furthermore, a program (for example, an application) may be stored in a device connected to a network such as the Internet, and the computer 100 may read the program from the device and execute the program. Furthermore, the program may be, for example, a plug-in program that adds a part or all of processing to an existing application.

### 5. Modifications

Although the embodiment of the present disclosure has been heretofore specifically described, the present disclosure is not limited to the above-described embodiments, and various modifications based on the technical idea of the present disclosure may be made. For example, various modifications to be described below may be made. Furthermore, one or a plurality of optionally selected aspects of the modifications to be described below may be appropriately combined. Furthermore, configurations, methods, processes, shapes, materials, numerical values, and the like of the above-described embodiments may be combined or exchanged with each other without departing from the gist of the present disclosure. Furthermore, one of the above may be divided into two or more, and a part thereof may be omitted.

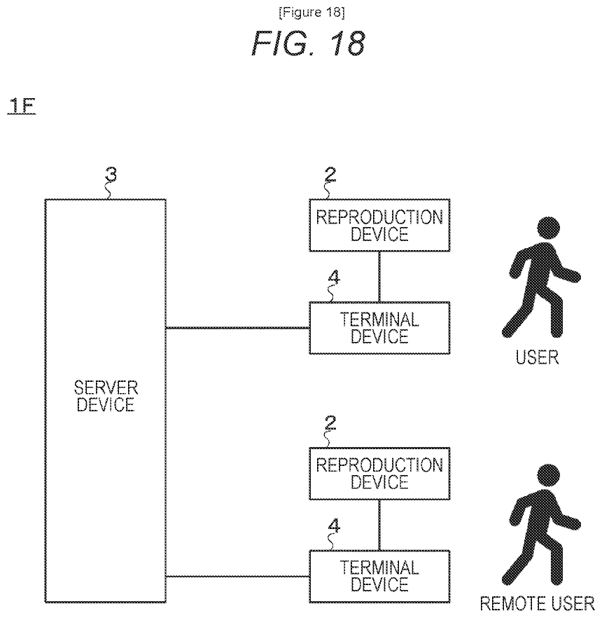

For example, in the embodiment described above, the generation of the reproduction signal according to the head position of the user has been described, but the present invention is not limited thereto. In addition, the observation target sensed by the sensor unit is not limited to the same user, and may be other than a person (for example, a subject of a video in a remote place, or the like). Moreover, the sound image to be localized may be a stationary sound image or a moving sound image. FIG. 18 is a diagram illustrating a configuration example of a reproduction system (reproduction system 1E) according to a modification. The reproduction system 1F is a system that compensates for the communication delay between devices respectively used by a user and another remote user (remote user) to realize a virtual experience. The reproduction system 1F includes a reproduction device 2 and a terminal device 4 used by the user, a reproduction device 2 and a terminal device 4 used by the remote user, and a server device 3. Specifically, the reproduction system 1F reproduces content (for example, AR content) when each of the terminal devices 4 executes an application.

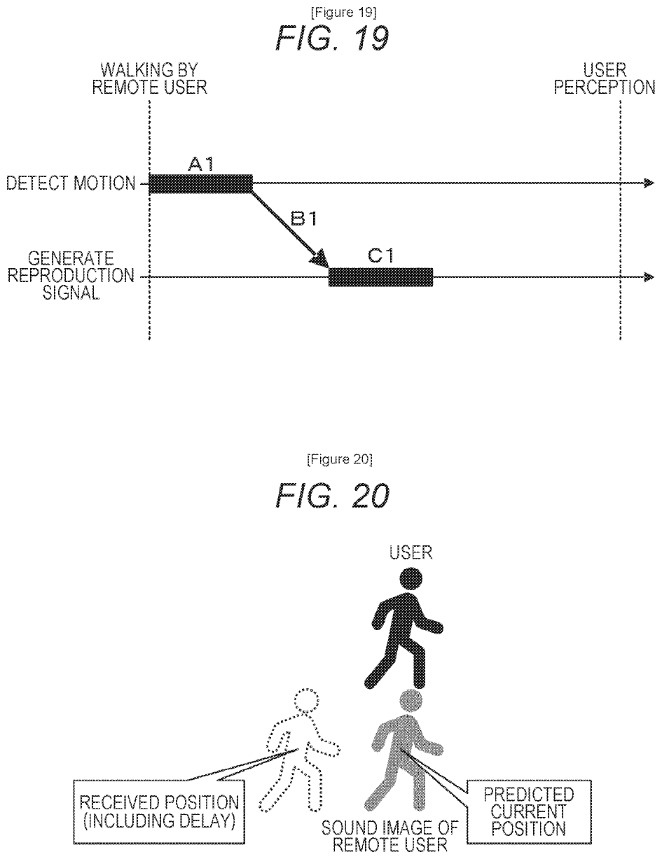

Specifically, the reproduction system 1F can realize an experience in which the user (main user) and the remote user walk side by side. FIG. 19 is a diagram briefly illustrating a flow of processing in the reproduction system 1F. First, the reproduction device 2 of the remote user senses the motion of the remote user (for example, a coordinate change due to walking or the like). The sensor value obtained by the sensing is transmitted to the terminal device 4 of the main user via the terminal device 4 and the server device 3. As this communication system, for example, cellular communication can be used. The terminal device 4 of the main user generates a sound source position (specifically, a position in the vicinity such as a side of the user) from the content (specifically, spoken voice of the remote user, and the like) distributed from the server device 3, and generates a reproduction signal (specifically, the audio signal of the spoken voice of the remote user) using the transmitted sensor value. The generated reproduction signal is transmitted to the reproduction device 2 of the user and is reproduced to cause a sound to be output.

In this way, by receiving the coordinate change of the remote user and reproducing the spoken voice of the remote user beside the main user, the experience of walking side by side can be realized. In this case, a delay (delay A1) when the reproduction device 2 of the remote user acquires the sensor value, a communication delay (delay B1) when the sensor value is transmitted to the terminal device 4 of the main user, a communication delay (delay C1) when the terminal device 4 of the main user generates the reproduction signal, and the like occur. As described above, because the position information of the remote user is transmitted with a delay due to the communication delay, even if the main user intends to walk next to the remote user, the main user on the other side will experience as if the remote user is following the main user a little later. However, because the movement of the user such as walking is also continuous, the current position can be predicted from the history of the position of the remote user similarly to the case of the above-described embodiment. Therefore, by predicting and compensating the amount of delay Td in consideration of these delays including the communication delay, it is possible to localize the spoken voice or the walking sound of the remote user can be localized to an optimal position (position subjected to delay compensation) and reproduce the spoken voice or the walking sound as illustrated in FIG. 20. That is, the user can have an experience without feeling delay. Note that the coordinates in the case of this example may be applied not only to the coordinates in the real space but also to a position change by a controller or the like in the VR space. In the present example, sound images of a plurality of remote users may be localized.

Furthermore, for example, in the above-described embodiment, the configuration in which the sensor unit is provided in any one of the reproduction device and the terminal device has been exemplified. For example, in the reproduction system 1, the sensor unit 21 is provided in the reproduction device 2. However, the sensor unit may be provided in both the reproduction device and the terminal device, and the facing direction of the head may be estimated using the sensor value output from each sensor unit. In this case, for example, the following application is possible. When the user is on a vehicle such as a train or a bus, if the vehicle turns a curve, and, for example, if the head angle is calculated only by the reproduction device, there is a possibility that the head is erroneously detected to have rotated. On the other hand, as described above, in a case where the head angle is calculated by both the reproduction device and the terminal device, it is possible to estimate whether the head is moving or the entire body is moving by taking the difference between the sensor values of both devices and making the correction, which can prevent the sound image localization processing from malfunctioning in a case where the vehicle merely turns a curve. Note that the sensor unit 21 may be provided in the server device similarly to the terminal device as long as the server device can be carried by the user.

Furthermore, for example, in the above-described embodiment, the case of performing the sound image localization has been exemplified, but the localization target is not limited to sound. For example, the present invention may be applied to images, vibrations, force senses, and the like. With this arrangement, for example, the delays of various remote events, such as games can be compensated. That is, the present invention may be applied to those using senses such as visual sense and tactile sense other than auditory sense. Furthermore, the present invention may be applied to a device using a plurality of senses, such as a device using both auditory sense and visual sense. For example, in the sound image localization described above, a position may be displayed as an image on a screen of a smartphone, an AR glass, or the like. In this case, the above-described delay prediction can also be applied to the display. Moreover, the delay may be intentionally increased to give a motion feeling.

Note that the present disclosure may also adopt the following configurations.

(1)

An information processing apparatus including
a control unit that performs processing of: performing prediction of a total amount of delay that changes according to a state of a reproduction system including a sensor unit that senses a position of an observation target and a reproduction unit that reproduces a reproduction signal generated on the basis of sensing data of the sensor unit, the total amount of delay possibly occurring between sensing by the sensor unit and reproduction by the reproduction unit; and compensating for a delay of the predicted total amount of delay and then generating the reproduction signal.
   (2)

The information processing apparatus according to (1), in which
the reproduction unit is mounted on a head of a user and outputs a sound,
the sensor unit senses a position of the user, and
the control unit calculates, on the basis of the sensing data, a head position of the user after the total amount of delay has elapsed, and generates the reproduction signal by performing sound image localization processing on an audio signal, the sound image localization processing corresponding to the head position that has been calculated.
   (3)

The information processing apparatus according to (1) or (2), in which
the control unit acquires state information representing a current state of the reproduction system and setting information representing a preset amount of delay in each state of the reproduction system, reads the amount of delay in the current state of the reproduction system from the setting information, the current state being represented by the state information, and performs the prediction using the read amount of delay.
   (4)

The information processing apparatus according to (3), in which
the state information includes information regarding the setting of wireless communication in a case where the wireless communication is performed between the sensor unit and the reproduction unit.
   (5)

The information processing apparatus according to (3) or (4), in which
the state information includes information regarding models of a device including the sensor unit, the information processing device, and a device including the reproduction unit.
   (6)

The information processing apparatus according to any one of (3) to (5), in which,
in a case where the total amount of delay is smaller than a predetermined threshold value, the control unit does not compensate for the delay.
   (7)

The information processing apparatus according to any one of (3) to (6), in which,
in a case where the total amount of delay exceeds a predetermined time, the control unit determines that the prediction is difficult.
   (8)

The information processing apparatus according to any one of (3) to (7), in which
the control unit calculates a motion of the observation target, and in a case where a calculated value is equal to or more than a predetermined threshold value regarded as vigorous motion, the control unit determines that the prediction is difficult.
   (9)

The information processing apparatus according to any one of (3) to (8), in which,
the sensor unit includes a plurality of sensors, and
in a case where the prediction is difficult, the control unit changes the sensor to be used.
   (10)

The information processing apparatus according to any one of (3) to (9), in which,
in a case where the prediction is difficult, the control unit shortens an amount of prediction or switches to turn off the prediction.
   (11)

The information processing apparatus according to any one of (3) to (10), in which,
in a case where the prediction is difficult, the control unit switches to a mode of generating a reproduction signal of low quality with less delay than generation of the reproduction signal.
   (12)

The information processing apparatus according to any one of (3) to (11), in which,
in a case where the total amount of delay exceeds an upper limit of a preset amount of prediction, the control unit compensates for the delay to the upper limit of the amount of prediction.
   (13)

The information processing apparatus according to (12), in which
the reproduction unit is mounted on a head of a user and outputs a sound,
the sensor unit senses a position of the user,
the control unit calculates, on the basis of the sensing data, the position of the user after the total amount of delay has elapsed, and generates the reproduction signal by performing sound image localization processing on an audio signal, the sound image localization processing corresponding to the calculated position of the user, and
the upper limit of the amount of prediction is an amount until the position of the user faces a position that is sound image localized by the sound image localization processing.
   (14)

the information processing apparatus according to (1) or (2), in which
the control unit predicts the total amount of delay using a value actually measured in advance.
   (15)

An information processing method including performing processing of:
performing prediction of a total amount of delay that changes according to a state of a reproduction system including a sensor unit that senses a position of an observation target and a reproduction unit that reproduces a reproduction signal generated on the basis of sensing data of the sensor unit, the total amount of delay possibly occurring between sensing by the sensor unit and reproduction by the reproduction unit; and compensating for a delay of the predicted total amount of delay and then generating the reproduction signal.
   (16)

A program that causes a computer to execute processing of:
performing prediction of a total amount of delay that changes according to a state of a reproduction system including a sensor unit that senses a position of an observation target and a reproduction unit that reproduces a reproduction signal generated on the basis of sensing data of the sensor unit, the total amount of delay possibly occurring between sensing by the sensor unit and reproduction by the reproduction unit; and compensating for a delay of the predicted total amount of delay and then generating the reproduction signal.

### REFERENCE SIGNS LIST

1, 1A to 1F Reproduction system
2, 2A, 2B, 2D, 2E Reproduction device
4, 4A, 4B Terminal device
3, 3C Server device
21, 21B Sensor unit
22, 22A, 28 Reproduction unit
25, 25D Right-side reproduction device
27 Left-side reproduction device
43 Position calculation unit
44, 44A, 44B, 44D, 44E Delay compensation unit
45 Sound source position generation unit
46 Reproduction signal generation unit
100 Computer
101 Control unit

1. An information processing apparatus comprising
a control unit that performs processing of: performing prediction of a total amount of delay that changes according to a state of a reproduction system including a sensor unit that senses a position of an observation target and a reproduction unit that reproduces a reproduction signal generated on a basis of sensing data of the sensor unit, the total amount of delay possibly occurring between sensing by the sensor unit and reproduction by the reproduction unit; and compensating for a delay of the total amount of delay that has been predicted and then generating the reproduction signal.

2. The information processing apparatus according to claim 1, wherein
the reproduction unit is mounted on a head of a user and outputs a sound,
the sensor unit senses a position of the user, and
the control unit calculates, on a basis of the sensing data, a head position of the user after the total amount of delay has elapsed, and generates the reproduction signal by performing sound image localization processing on an audio signal, the sound image localization processing corresponding to the head position that has been calculated.

3. The information processing apparatus according to claim 1, wherein
the control unit acquires state information representing a current state of the reproduction system and setting information representing an amount of delay that is preset in each state of the reproduction system, reads the amount of delay in the current state of the reproduction system from the setting information, the current state being represented by the state information, and performs the prediction using the amount of delay that has been read.

4. The information processing apparatus according to claim 3, wherein
the state information includes information regarding setting of wireless communication in a case where the wireless communication is performed between the sensor unit and the reproduction unit.

5. The information processing apparatus according to claim 3, wherein
the state information includes information regarding models of a device including the sensor unit, the information processing device, and a device including the reproduction unit.

6. The information processing apparatus according to claim 3, wherein,
in a case where the total amount of delay is smaller than a predetermined threshold value, the control unit does not compensate for the delay.

7. The information processing apparatus according to claim 3, wherein,
in a case where the total amount of delay exceeds a predetermined time, the control unit determines that the prediction is difficult.

8. The information processing apparatus according to claim 3, wherein
the control unit calculates a motion of the observation target, and in a case where a calculated value is equal to or more than a predetermined threshold value regarded as vigorous motion, the control unit determines that the prediction is difficult.

9. The information processing apparatus according to claim 3, wherein
the sensor unit includes a plurality of sensors, and
in a case where the prediction is difficult, the control unit changes the sensor to be used.

10. The information processing apparatus according to claim 3, wherein,
in a case where the prediction is difficult, the control unit shortens an amount of prediction or switches to turn off the prediction.

11. The information processing apparatus according to claim 3, wherein,
in a case where the prediction is difficult, the control unit switches to a mode of generating a reproduction signal of low quality with less delay than generation of the reproduction signal.

12. The information processing apparatus according to claim 3, wherein,
in a case where the total amount of delay exceeds an upper limit of an amount of prediction that is preset, the control unit compensates for the delay to the upper limit of the amount of prediction.

13. The information processing apparatus according to claim 12, wherein
the reproduction unit is mounted on a head of a user and outputs a sound,
the sensor unit senses a position of the user,
the control unit calculates, on a basis of the sensing data, the position of the user after the total amount of delay has elapsed, and generates the reproduction signal by performing sound image localization processing on an audio signal, the sound image localization processing corresponding to the position of the user that has been calculated, and
the upper limit of the amount of prediction is an amount until the position of the user faces a position that is sound image localized by the sound image localization processing.

14. The information processing apparatus according to claim 1, wherein
the control unit predicts the total amount of delay using a value actually measured in advance.

15. An information processing method comprising performing processing of:
performing prediction of a total amount of delay that changes according to a state of a reproduction system including a sensor unit that senses a position of an observation target and a reproduction unit that reproduces a reproduction signal generated on a basis of sensing data of the sensor unit, the total amount of delay possibly occurring between sensing by the sensor unit and reproduction by the reproduction unit; and compensating for a delay of the total amount of delay that has been predicted and then generating the reproduction signal.

16. A program that causes a computer to execute processing of:
performing prediction of a total amount of delay that changes according to a state of a reproduction system including a sensor unit that senses a position of an observation target and a reproduction unit that reproduces a reproduction signal generated on a basis of sensing data of the sensor unit, the total amount of delay possibly occurring between sensing by the sensor unit and reproduction by the reproduction unit; and compensating for a delay of the total amount of delay that has been predicted and then generating the reproduction signal.
